(19) United States
(12) Patent Application Publication
(10) Pub. No.: US 2003/0196167 A1
(43) Pub. Date: Oct. 16, 2003

(54) Computer management system for managing information and actions for businesses or professional organizations

(75) Inventor: Gregory John Dewar, Queensland (AU)

Correspondence Address: YOUNG & THOMPSON, 745 SOUTH 23RD STREET 2ND FLOOR, ARLINGTON, VA, 22202

(73) Assignee: EPITROPOS PTY LTD., QUEENSLAND (AU)

(21) Appl. No.: 10/410,106

(22) Filed: Apr. 10, 2003

Related U.S. Application Data
(63) Continuation of application No. 09/529,978, filed on Apr. 24, 2000.
Application No. 09/529,978 is a 371 of international application No. PCT/AU98/00887, filed on Oct. 26, 1998.

(30) Foreign Application Priority Data
Oct. 24, 1997 (AU) PO9987
Mar. 2, 1998 (AU) PP2078

(51) Int. Cl. G06F 15/00

(52) U.S. Cl. 715/507

(57) ABSTRACT

A computer management system is provided for operating a computer and application programs from projects. The system stores information related to individual projects in memory of the computer and comprises project selection means for selecting a desired project and linking means for linking information and tasks related to each project. The linking means has a file path including task categories and information classes for each task category so that documents for each class are automatically saved in a predefined path. The information classes are adapted to contain document identifications. In use the selection means is used to select a project and from which a desired document in an information class can be selected. The system can create a new project with newly defined linkages, save off an existing project or model on a project template. Any of the projects can be made a project template. The linking means also has a database containing contact and client details from which the details are retrieved and inserted automatically in bookmarked positions in a document being created. The application program for a selected document is run automatically on selecting the document.

### FIELD OF THE INVENTION

THIS INVENTION relates to a computer management system for managing information and tasks for businesses or professional organisations, and in particular but not limited thereto to a computer management system for managing information and tasks for a business or professional project so that all information and tasks for the project made available to a particular user are accessible within a single project folder.

### BACKGROUND TO THE INVENTION

The applicant has worked in a number of business and professional organisations in different countries and has found that people in these organisations continue to use paper based correspondence and other documents despite advances made in the computer industries in recent years. The aim of a paperless office is therefore far from realisation.

Amongst many of the reasons for the continuing use of paper based documents are difficulties in locating desired information stored on the computer system and many information such as client addresses and formats of correspondence required for tasks to be done on the computer system need to be manually entered each time a document is to be created, after spending considerable time finding the addresses and deciding on the appropriate formats and layouts for the documents. In addition the tasks for a project generally require the use of different application programs which need to be located and opened. Often files saved by the programs are difficult to identify, and if there are many files they are also difficult to find as there is no logical filing system and different users name files in accordance to their preferences.

Fear of the security of computer records is another reason for people to continue to use paper based documents.

Accounting packages currently in use are solely for accounting purposes. These packages do not allow for monitoring of project performance of production staff.

### OBJECT OF THE INVENTION

It is an object of the present invention to provide a computer management system which alleviates or reduces to a certain level one or more of the prior art disadvantages.

Other objects will be evident from the following description.

### DISCLOSURE OF THE INVENTION

In one aspect the present invention resides in a computer management system comprising project selection means for selecting any one of a plurality of projects, the projects each having related information stored on memory means of the computer system, and means for linking information and tasks related to each project. The linking means is arranged so that the selection means can be selectively activated to present one or more task categories and one or more information classes in each task category. Each information class is adapted to hold documents, when created, intended for this class so that information relevant to a particular class in a task category can be obtained by selecting the appropriate task category and information class.

In another aspect the present invention resides in a management program stored on a computer readable medium, the program comprising project selection means for selecting any one of a plurality of projects, the projects each having related information stored on memory means of the computer system, and means for linking information and tasks related to each project. The linking means is arranged so that the selection means can be selectively activated to present one or more task categories and one or more information classes in each task category. Each information class is adapted to hold documents, when created, intended for this class so that information relevant to a particular class in a task category can be obtained by selecting the appropriate task category and information class.

It should be noted that the term “project” as used herein includes any construction projects, research projects, commercial projects, educational projects, financial projects, legal projects and the like; and the term “document” includes one or a combination of two or more of a letter, an accounting or financial report, a time costing report, a project report, a drawing, picture, graphic or other image, and an audio file.

Hereinafter the word “system” should be considered to include “software” for features common to the aspects of the present invention.

Any of the task categories may include one or more sub-categories and the system has sub-category selection means for selecting the sub-category or any one of the sub-categories. In an example the sub-categories are in the form of recipients of the tasks.

In an embodiment the task categories for an architecture project include project information, contract fees, correspondence, design, meetings, authorities, program, budget costs, production, tender, contract administration, and close out. The recipients for this embodiment include acoustic engineer, builder, client, electrical engineer, general matters, hydraulic engineer, interior designer, mechanical engineer, quantity surveyor, and structural engineer.

The information classes may include fax, letter, memo, telephone log and report.

Preferably the system of the present invention includes invoking means for invoking an appropriate application program when a document in an information class is to be created or selected.

Desirably the linking means includes a linkage database containing the information relevant to the or each information class. The linking means may also include a filing arrangement for automatic filing documents under the relevant information classes for the task categories.

The system conveniently includes project creation means for creating a new project. The project creation means may have a project template selector for selecting a project template for the new project from a library of project templates stored in the memory means. The selected project template typically has forms on which information for the new project are entered; and project modifying means for modifying a project. Alternatively the project creation means may copy an existing project as a new project.

Conveniently the system of the present invention has a database of information and certain information for the forms can be called from the database and inserted automatically. Typically this database includes contact details such as recipient details.

The system may also include a library of document templates which can be accessed within an application program. The linking means is arranged so that predetermined document templates are automatically linked to relevant information classes.

Typically the system includes a document template creation means for adding to the library of document templates and document template modifying means for modifying a document template.

Desirably the contact database and the document templates are linked to projects so that appropriate information in the database relevant document templates are available to the projects. This reduces computer memory usage by the system as information common to different projects need not be separately stored.

The system of the present invention may have stored graphics such as office logo for insertion into documents. Desirably the graphics are automatically inserted into an appropriate location of a document when printing or when sending the document through a communications system such as email or facsimile. The graphics are advantageously not inserted in the document when saving or archiving in order to minimise the size of required computer storage.

Conveniently communications programs such as email, facsimile, internet browser, and the like are invokable through the system. More conveniently any of these communications programs can be invoked by a user command or selecting an icon or button within any stage of the system.

Desirably information related to an information class within a task category or a sub-category is made readily accessible. Said desirable information may be memo, telephone messages and the like which are associated with the task. It is also desirable that email message, diary, contact listing and/or “to do” list for the user are made readily available. The availability can be selected by entering appropriate user commands which may be buttons or icons for activation on the computer screen.

It is particularly advantageous that the system of the present invention has means for intercepting a save command entered within any of the application programs so that all documents or files for the selected project are saved in predetermined folders. More particularly, the linking means has a file path determining means which automatically save to and retrieve from the predetermined folders. The file path allows users to find files logically.

In order to prevent tampering of any saved documents/files, the system of the present invention may have means for preventing tampering of records and/or files of any of the projects. Such means include designating all or selected save files and/or records as “read only”, and/or with password protection. The tampering preventing means can be made password sensitive so that certain functions and activities are not active for users not authorised to alter files and/or records.

Desirably the system of the present invention has password verification means so that only a user supplying the correct/password for the user can have access to the system. Preferably the system has different levels of access so that users can only have access to projects and/or certain information and certain functions/activities in projects which are made available to those users.

It is also desirable that the system of the present invention has a backup facility so that a copy of the database and the projects stored on the memory means of the computer system is made regularly and/or upon receiving an appropriate user command. Preferably the backup facility is invoked routinely.

The system of the present invention may be provided with an archiving means for archiving records and information of the projects stored on the memory means. The archiving means is advantageously selective so that the user can select any of the projects or any records or information associated with one or more selected projects for archiving.

The system of the present invention can also be provided with a restoring means for selectively restoring any record or information that has been archived.

The system may also have an audit trail facility which allows an auditor to trace information such as documents created, documents transmitted, letters forwarded, receipt issued, etc.

The system is desirably adaptive so that other application programs and add on modules for specific projects or additional functionalities can be easily incorporated into the system. Time/cost project management module is one such add on module for the system. The time/cost module may be used by project team managers and production staff to monitor their performance, the project's performance and their percentage chargeable time.

In a further aspect the present invention resides in a monitoring system for monitoring project performance. The monitoring system includes memory means for storing information relating to one or more projects and information relating to members working on the one or more projects; and programming means arranged for providing project performance. The project performance and/or individual member performance are derived from the stored project information and the member information.

Typically the project information and the member information are arranged in a database stored on the memory means.

The database includes one or more project records and one or more member records. Each project record includes a unique project identification and project costs. The project identification may be a unique number field for each project and may also include a project name field and/or manager name field.

Desirably the unique project number field includes a start component which indicates project starting year and a sequentially incremental project number for that year. It can also include a component which indicate a cost category of the project.

The project costs may advantageously include a project type field and/or an overhead allocation field.

The project type may include regular cost components such as direct labour costs, direct expenses, reimbursements and “rework” costs; overhead cost components such as indirect labour costs and indirect expenses; and promotional project components for projects overlapping fiscal years.

Examples of the indirect labour costs and indirect expenses are general overhead, vacation, sick leave, holiday, business development, accounting, research and development, civic duty, professional development and the like.

Each member record typically includes a unique member identification filed and a member class field. The unique member identification field may include a unique member number component and member name component.

The member class field may include a member class component for charge out level determination, a base pay rate component for actual project costs consideration.

If members are to be paid overtime then the member class field may also include an overtime component.

If members have both chargeable and non-chargeable times then each member record can have a target ratio of chargeable to non-chargeable times.

It is advantageous that each project record and each member record have a grouping field so that performance of the grouping can also be indicated. Typically the grouping is a department or a section of an organisation.

In preference the monitoring system of the present invention includes an online time sheet entry form for entering information relating to work done on the one or more projects. Typically the time entry form includes information for period ending, member number, grouping, chargeable time, non-chargeable time, hourly rate, expenses and the like, whereby performance of members and/or groupings and/or projects can be monitored. The monitored performance may also be used in predicting suitable staff members, budget and timings for future projects.

The individual member performance may be in the form of a ratio of actual chargeable vs non-chargeable time. Desirably this ratio is superimposed on a target ratio so that each member can view performance against the target ratio.

The actual ratio and the target ratio is preferably calculated to the current period ending and/or the year to date.

The individual member performance may also include an indication of time expended vs budgeted time.

The monitoring system of the present invention can be provided with another online information entry form for entering allowable expenses. Said allowable expenses may include outside consultant services, travel and meals, reproductions, telephone charges, etc.

Desirably outside consultant services information entry is on a separate form which schedules each consultant and provides reconciliation of the fees expended, accrued, billed or not, and paid.

Conveniently the monitoring system of the present invention has a fee billing facility for the or each project. In the fee billing facility, labour costs, outside consultant fees and reimbursements may be included as fixed costs, time charges, or variations of these for various parts of a project.

If is preferred that relevant information stored on the memory means can be exported to an accounting package which performs general accounting tasks.

It is also preferred that the monitoring system of the present invention has import facility for importing relevant information from the accounting package.

As a security measure, the information entered for the time sheet entry and/or for outside consultant services must be authorised by a person with an appropriate password before they can be posted into the system.

The programming means is arranged to select the appropriate information stored on the memory means and to perform operations to generate one or more of the following reports:

Time analysis report;

Project progress report (including projected cash low report);

Project detail report;

Project summary report (including projected cash flow report); and

Reports to focus on pareito information.

The programming means may also be adapted to generate a “resource balancer” report based on the member class field. The “resource balancer” report allows projects to be prioritised and members to be allocated to projects by class on the basis of the resource available and project demands.

The “rework” component may be used to generate a report which identifies projects or parts of projects which have a high rework component.

The relevant information exported to the accounting package can be used to generate the followings:

Invoicing information;

Wages time data;

Disbursements; and

Project data.

It is preferred that the monitoring system has a multi-level security access arrangement so that members have different levels of access. As an example, the security access arrangement has 4 levels of access and the access for each level may be as follows:

| | |
|---|---|
| System defaults | 1 |
| Export files to accounting system | 1 |
| Check time sheets before posting | 2 |
| Check project budgets before posting | 2 |
| Create reports (Firmwide) | 2 |
| Check and modify other data entry before posting | 2 |
| Create a new project | 2 |
| Archive or delete a project | 2 |
| Back-up (in single user version) | 2 |
| Create a project budget | 3 |
| Modify budgets monthly | 3 |
| Create Reports particular to Department | 3 |
| Create and reconcile fee invoicing | 3 |
| Reconcile outside consultant fees | 3 |
| Enter direct expenses data | 3 |
| Enter own time sheets | 4 |
| View data specific to own projects | 4 |

The monitoring system may be a stand-alone system or an add on module or an integral part of the system described earlier as one aspect or another aspect of the invention.

The applicant has ingenuously developed a number of features which work in synergism together. Each or combinations of selected ones of the features may be considered inventive and the applicant reserves the right to divide out any of the inventive features or combinations in separate applications.

The system according to a preferred embodiment of the present invention allows a user to operate a computer in projects, and jobs or matters relevant to a selected project. The system allows a project to be created by selecting a predefined project template which has predetermined links between task categories, task sub-categories, information classes and document templates within each class; or copied from an existing project whereby workflows, jobs or matters in a previous project can be easily duplicated. A document to be created can be selected from a document template, and contact and/or recipient details are entered automatically in the document once the contact and/or recipient are identified. The system runs an application program for a selected document automatically and saves the document in a predefined file path. Project creations within an organisation are therefore largely automatic and highly consistent. Once created the documents are filed in a predetermined file path within a project, and therefore allows a subsequent user to locate it easily.

### BRIEF DESCRIPTION OF THE DRAWINGS

In order that the present invention can be readily understood and put into practical effect the description will now be made in reference to the accompanying drawings which illustrate preferred embodiments of the present invention and wherein:—

FIG. 1 is an overall flow diagram showing major linkages between major components of an embodiment of the computer management system according to the present invention;

FIG. 2 shows a main screen of the computer system shown in FIG. 1;

FIG. 3 shows a screen containing project details following selection of a project in the screen of FIG. 2;

FIG. 4 shows the FIG. 2 screen with expanded project icons;

FIG. 5 shows a screen containing details of a master project profile;

FIG. 6 shows a screen in the new document wizard;

FIG. 7 shows a screen containing a list of contacts;

FIG. 8 shows a document log containing history of actions on the documents;

FIG. 9 shows a screen containing staff timesheets;

FIG. 10 shows a screen for timesheet detail entry;

FIGS. 11 and 12 are forms for entering contact details;

FIGS. 13 and 15 are forms for entering budget details;

FIGS. 16 and 17 are forms for entering fees details;

FIGS. 18 and 19 are time cost reports;

FIG. 20 is a flow diagram showing a project monitoring system according to the present invention functioning as an add on module for a computer management system and interfacing with an accounting system; and

FIG. 21 is a hierarchical report order for the monitoring system shown in FIG. 20.

### DETAILED DESCRIPTION OF THE DRAWINGS

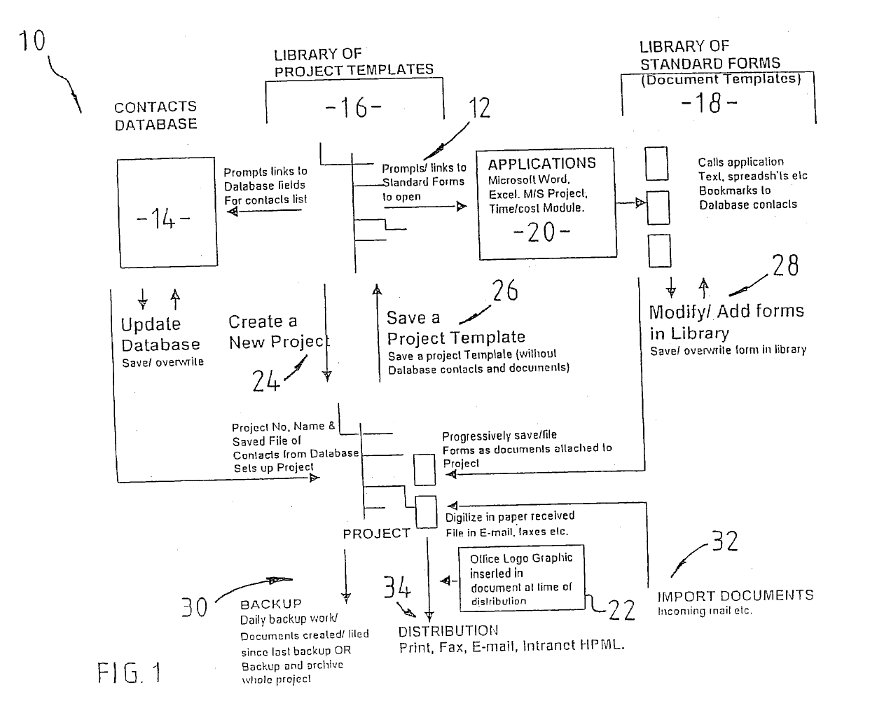

Referring to FIG. 1, there is shown an overall flow diagram for the computer management system 10 according to the present invention. As can be seen the system 10 has linking means 12 with linkages to a contact database 14, a library 16 of project templates, and a library 18 of document templates. The linking means 12 automatically invokes an appropriate application from stored applications 20 when a document template or a document is selected.

The selected document or document template has predefined locations or bookmarks where contact details from the contact database 14 and office logo 22 are to be inserted. The system 10 also has a project creation function 24 to create new projects and saving means 26 for saving a created project as a project template. A modifying means 28 for modifying the library 18 is provided for editing an existing document template or adding a new document template in the library 18.

The linking means 12 progressively save and/or file template documents as documents attached to the selected project in a predefined file path; and the saved documents are linked to the project number and contacts from the database 14.

The linkages, the bookmarks, the application program to be invoked and the file path for each document in a project are contained in a linkage database (not shown).

The system 10 also has a backup function 30 for backing up documents periodically or for archiving selected projects. The system-10 allows documents 32 such as facsimiles, email, scanned documents etc. to be imported. A distribution means 34 is included for distributing created documents and imported documents to targeted computers in a network. In order to save computer storage the office logo is not saved in the created documents.

This system 10 utilises the Microsoft Window™ login password for validating access and access level allowed for the user. If desired a separate login menu for the computer management system 10 can be incorporated. The login menu may be a window or a box on the computer monitor. It will prompt a user to enter the user name at the user prompt and password at the password prompt. When they are entered the system checks the entered name and compares the entered password with a previously stored password for the entered user name. If the user name is not on a list of authorised users the system alerts the user and prompt for another user name. If the entered user name is found on a user database but the entered password does not match the one on the databases the system prompts the user to re-enter the password. The system will allow access to the next phase of the system only when the entered user name is authorised and the entered password matches the one stored on the database.

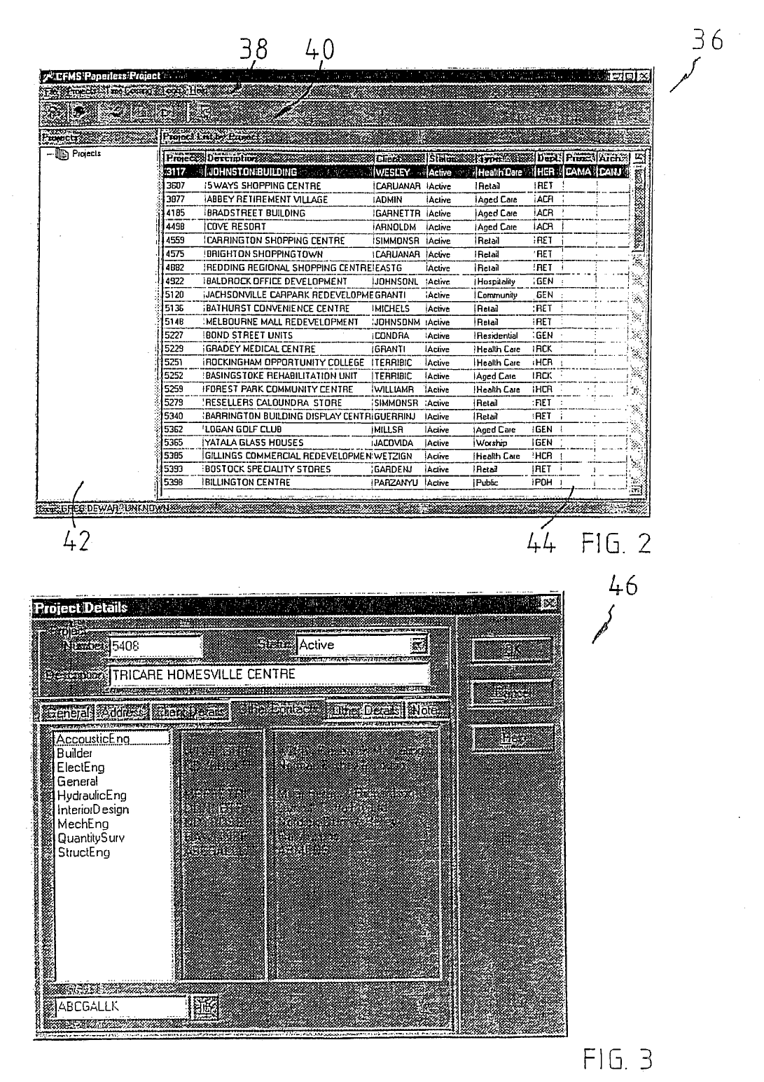

When the system 10 is operating it initially presents a main screen 36 as shown in FIG. 2. The screen 36 allows the user to select functions through drop down menus 38 identified by the titles “File”, “Projects”, “TimeCosting”, “Tools” and “Help”.

Selecting “File” allows the user to access to the functions “New Project”, “Edit Project”, “Delete Project”, “Document Template Editor”, “New Document Wizard”, “Search dor Documents” and “Document Import”. Under “Project” the functions can be accessed are “Budget”, “Fees”, “Master Project Profile Editor” and “Project Profile Editor”. “Timesheets”, “Reports”, “Master Phases” and “Project Phases” can be selected under “TimeCosting” and “Contacts”, “Departments”, “Classes”, “Activities”, “Staff”, “Company Logo”, and “Defaults” under “Tools”. The “Help” drop down menu has the usual function “Help” as well as “Database Explorer”.

The screen 36 also has radio buttons 40 for frequently used functions which in this embodiment are “New Project”, “Edit Project”, “Add/Edit Contacts”, “New Documents”, “Document Search” and “Timesheets”.

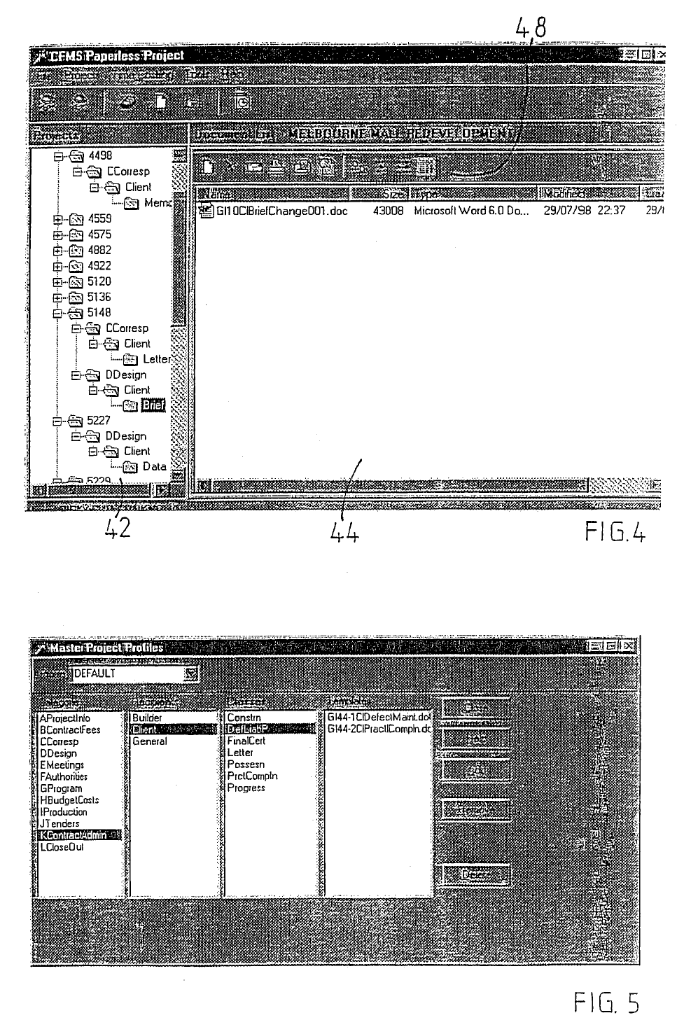

Below the radio buttons 40 are a left window 42 containing project icons and a left window 44 containing a list project details. More details of a project is accessible in a further window 46 as shown in FIG. 3 by selecting the project in the window 42. The project icons in the window 42 can be expanded by selecting to show a hierarchical filing structure as shown in FIG. 4. The tree structure shows the linkages between the task types, recipients and document classes for each project. In the example shown in FIG. 4, project no. 5148 has two task types (CCoresp for correspondence and DDEsign for design). For CCoresp the recipients are clients and document class is letter. For DDesign the recipients are also clients and the document class is briefs. While FIG. 4 shows a single recipient sub-category and a single document class for a task type the system 10 may have a plurality of recipient sub-categories and a plurality of document classes selected from a mater project profile as in FIG. 5

Referring again to FIG. 4 when a document class is selected the system 10 presents another set of radio buttons 48 in window 44. These radio buttons include the functions for creating a new document, removing a document, sending a document, printing a document, transferring a document in the document class and editing a document.

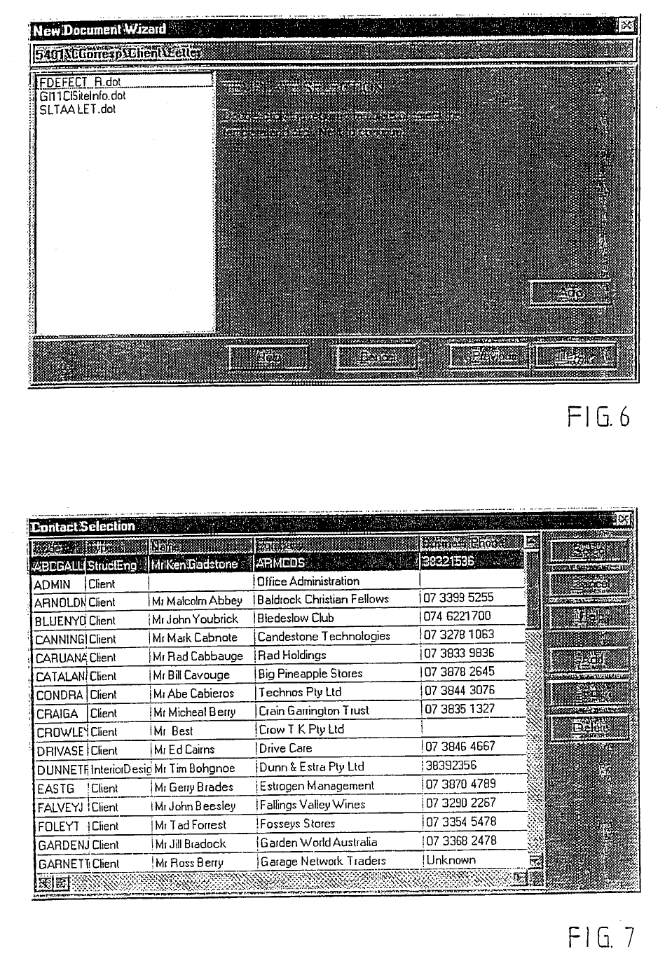

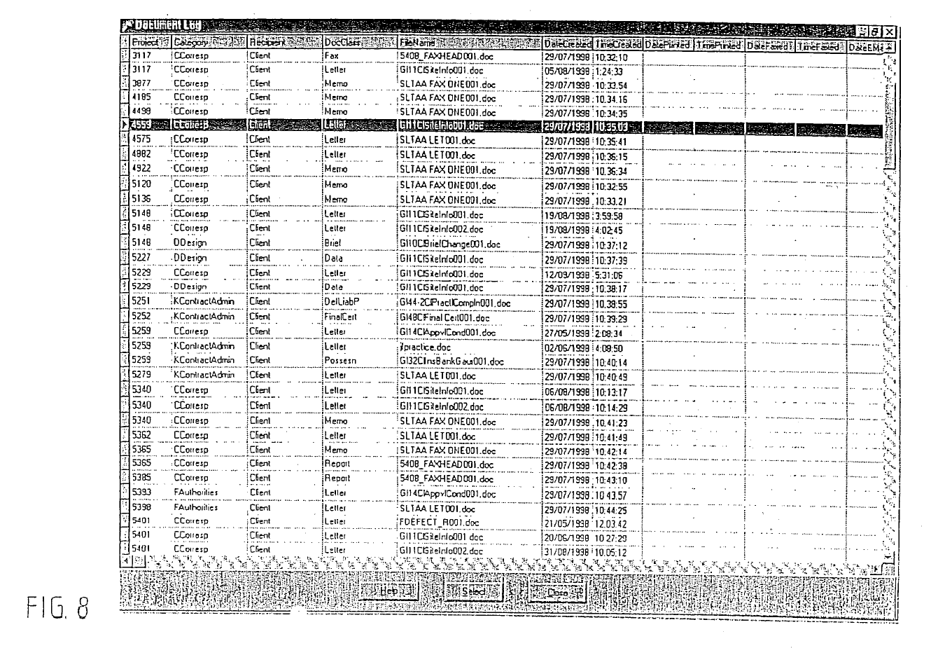

When the new document radio button is selected the system 10 presents a document template selection screen as shown in FIG. 6. The user may select one of the existing template or add a new template to the linkages. Upon selection of a template the system 10 prompts the user to enter a document category, recipient and document class before invoking an application program appropriate for creating the document.

FIG. 7 shows a contact selection screen which is revealed when the add/edit radio button is pressed. The user can select a desired contact to be inserted in a bookmarked position in a document. This screen also allows the user to add, edit or delete any of the contacts.

Pressing the document search button reveals a document log as shown in FIG. 8 with history of actions on the documents. This allows the user to ascertain the actions taken in relation to any documents in a quality assurance operation or audit trail operation.

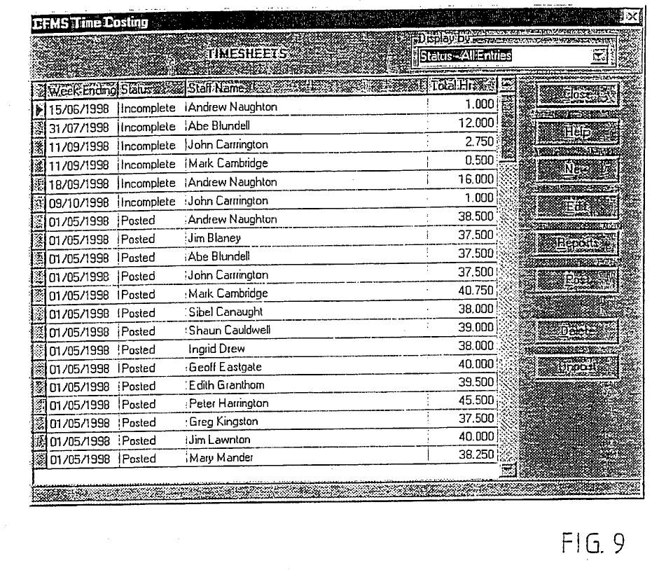

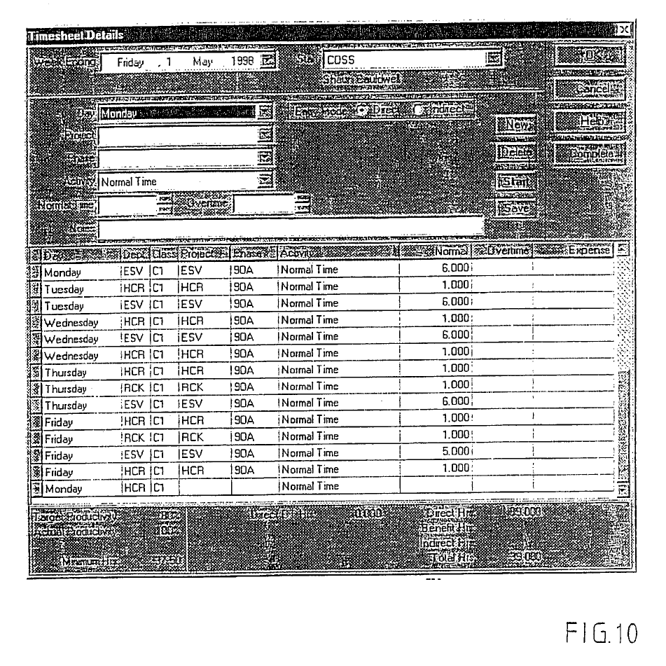

The time sheet radio button allows access to timesheets of staff members as shown in FIG. 9. This screen may be selectively chosen to display the timesheets of all entries, only incomplete entries, all staff, user only or by week ending date. FIG. 10 is a form for entering or editing timesheet details and is accessed by selecting the “New” or “Edit” prompt in FIG. 9.

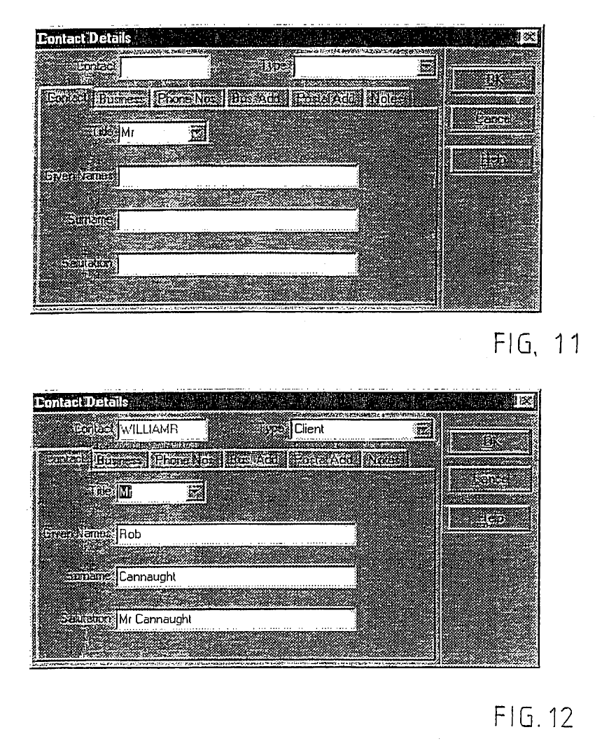

FIGS. 11 and 12 are respectively “Add” and “Edit” form for the contact details and they are accessible through the contact selection screen shown in FIG. 7.

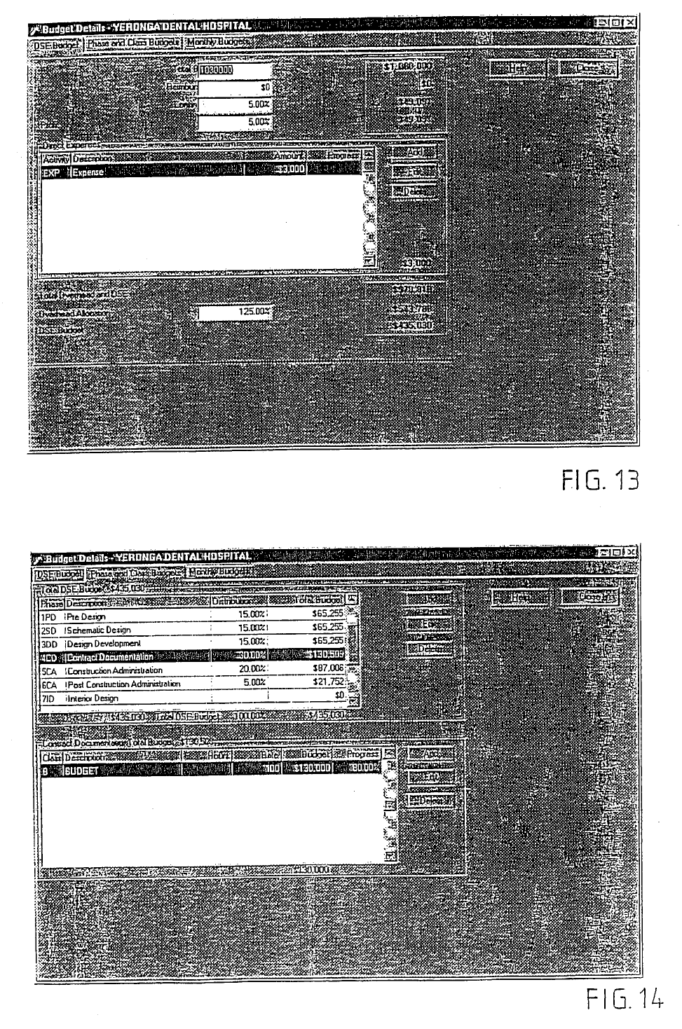

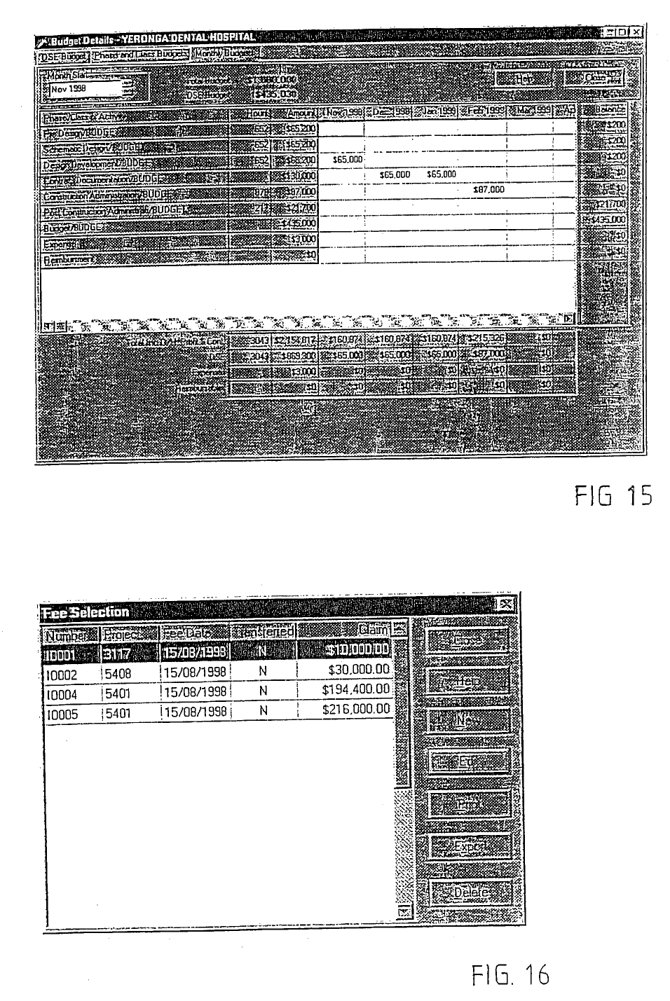

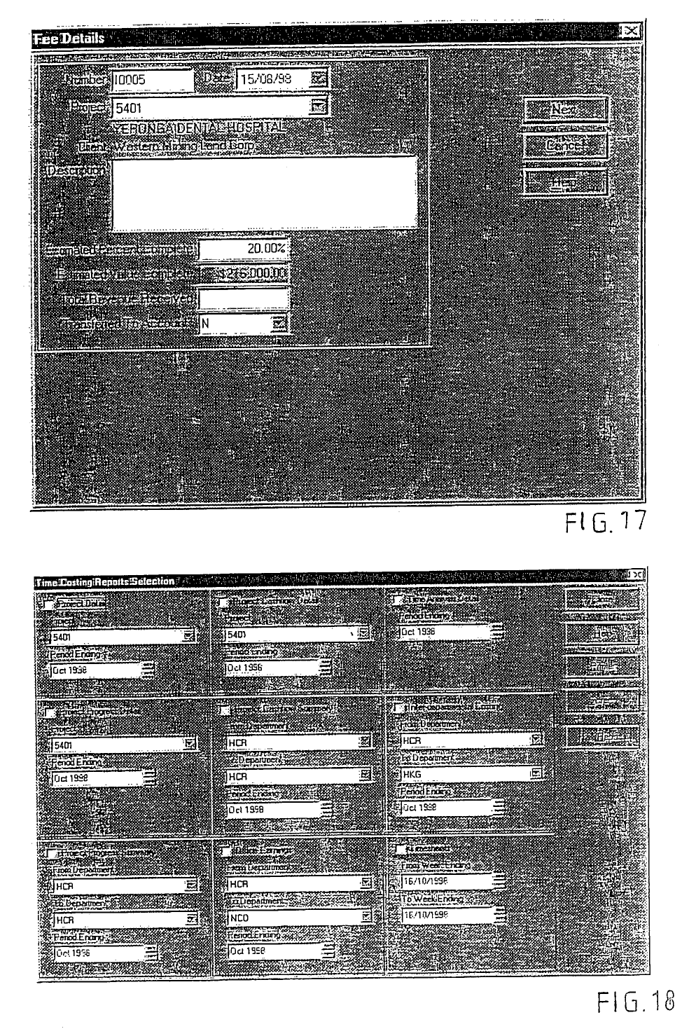

FIGS. 13 to 15 shows forms for entering budget details and FIGS. 16 and 17 forms for fees details.

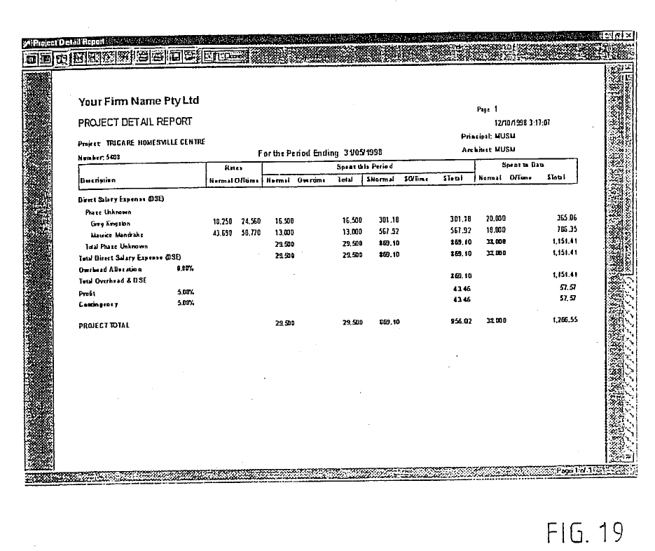

TimeCosting reports are shown in FIGS. 18 and 19.

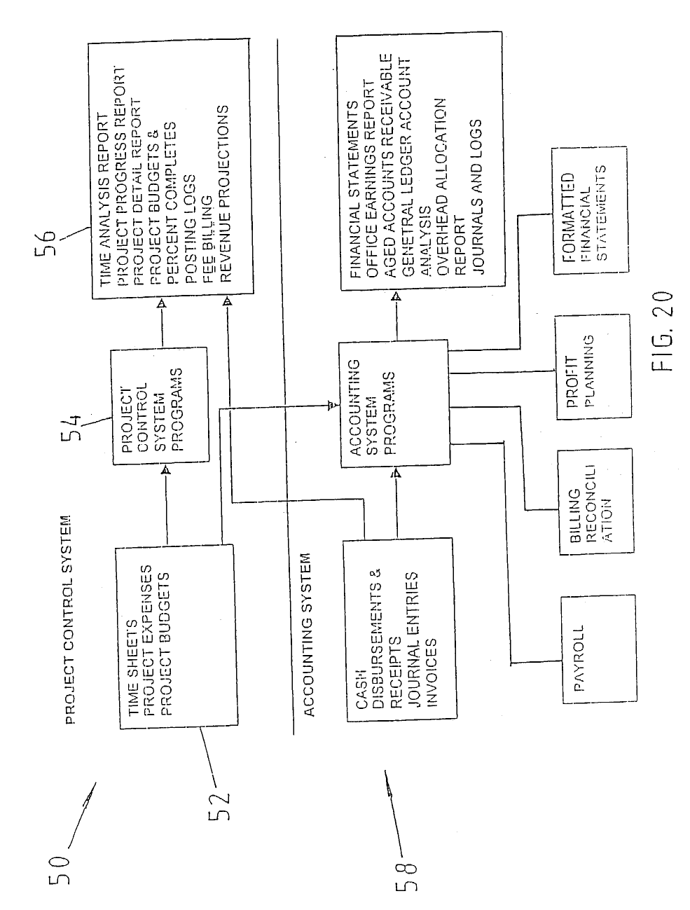

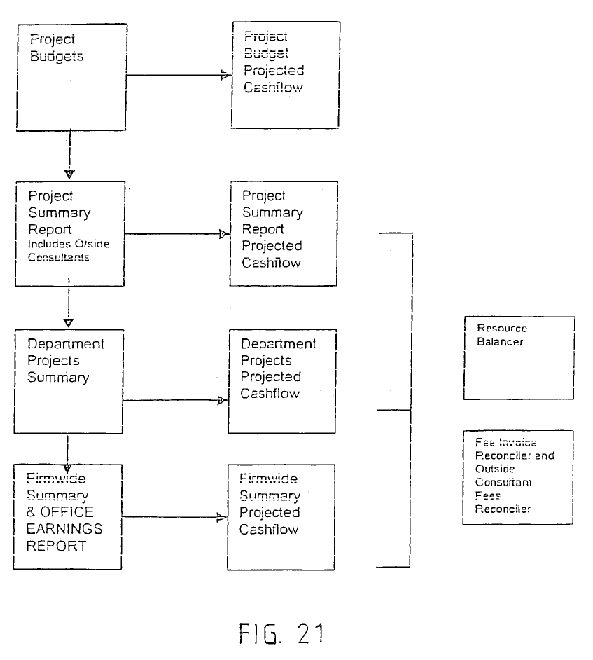

Referring now to FIG. 20, there is shown a project monitoring system 50, in this case a project control system, in accordance with another embodiment of the present invention. The system 50 as shown is linked to an accounting system 58.

The monitoring system has input means 52 which enable users to enter time sheet information, project expenses and project budgets. The entered data are stored in storage means such as a hard disk.

Programming means 54, in this case project control system programs, selects appropriate data from the hard disk to generate one or more reports at output means 56. The output means 56 can be a computer monitor or a printer.

As can be seen entered data are exported to the accounting system 58 for generating other reports. The monitoring system 50 is programmed so that it can use information normally associated with the accounting system 58 for generating appropriate reports.

Although not shown it should be understood that the monitoring system 50 has a multi-level access arrangement so that only users with the appropriately authorised passwords can access facilities allocated under the passwords.

As a further security measure identification codes (PIN) corresponding to respective passwords must be entered before the users are allowed access to any facility provided by the system 50.

In an exemplary application of the system 50, at the beginning of an accounting period or fiscal year all the files for the system are initialised. This may require the system to “rule off” the data so that actuals are recorded at the expiration of the period. Staff members can then enter and post time sheet details at, say, each pay period. Expenses and reimburseable items are also entered and posted regularly.

Budgets for projects are entered typically by project managers about 14 days ahead of monthly budgets and projections of budgets are entered about 6 months ahead.

Regular review of the monthly budgets and projections are necessary so that any variations can be taken account off.

The budgets and projections are used to generate cash flow reports.

Resources based on the budgets and time sheet data can be used to check against projects and then balanced resources can be allocated firmwide.

In this example, projects are grouped and staff members may work on projects from various groups. Therefore resource balancing between groups can involve rearranging staff resources between groups to suit particular demands and priorities.

As each member record has a class component, the classes of staff members can be readily interchanged between projects and they facilitate resource balancing.

At the end of each accounting period each project manager estimates the stages in each phase of the projects worked on during that period.

The time sheets and expenses of staff members, outside consultant fees which have been expended and to be completed are also entered at this stage.

Projected cash flow budgets are then reviewed.

Hierarchical reports as shown in FIG. 20 can the be generated for project monitoring.

Whilst the above has been given by way of illustrative example of the present invention, many variations and modifications thereto will be apparent to those skilled in the art without departing from the broad ambit and scope of the invention as herein set forth.

1. A computer system for managing plural projects, comprising:
a contacts database containing information about entities for whom the plural projects are being performed;
a document form database of standard forms for use in the plural projects;
a template database of standard templates for defining the plural projects using data from said contacts and document databases, completed ones of the standard templates being saved as project templates wherein data from said contacts and document form databases are not saved with the project templates; and
a linking means for linking the project templates to said contacts and document form databases to automatically incorporate appropriate data therefrom when the project templates are recalled.

2. The system of claim 1, further comprising plural applications for generating documents and correspondence for the plural projects and for storing the generated documents and correspondence using file paths associated with respective ones of the plural projects, and wherein said linking means automatically assigns the file paths for the generated documents and correspondence.

3. The system of claim 2, wherein said contacts database comprises plural categories of recipients of the generated correspondence, and wherein said linking means automatically assigns the generated correspondence to an appropriate one of said categories of recipients that appears in the assigned file path.

4. The system of claim 2, wherein said document form database comprises plural categories of the documents, and wherein said linking means automatically assigns the generated documents to an appropriate one of said categories of the documents that appears in the assigned file path.

5. The system of claim 2, wherein said linking means comprises a linkage database for storing the assigned file paths.

6. The system of claim 1, further comprising project creation means for creating a new one of the plural projects using said template, document form, and contacts databases.

7. A computer system for managing plural projects, comprising:
a contacts database containing information about entities for whom the plural projects are being performed;
a document form database of standard forms for use in the plural projects;
a template database of standard templates for defining the plural projects, completed ones of the standard templates being saved as project templates;
plural applications for generating documents and correspondence for the plural projects and for storing the generated documents and correspondence using file paths associated with respective ones of the plural projects; and
linking means for linking the project templates to said contacts and document form databases, for linking said plural applications to the project templates and to said contacts and document form databases, and for automatically assigning the file paths for the generated documents and correspondence.

8. The system of claim 7, wherein said contacts database comprises plural categories of recipients of the generated correspondence, and wherein said linking means automatically assigns the generated correspondence to an appropriate one of said categories of recipients that appears in the assigned file path.

9. The system of claim 7, wherein said document form database comprises plural categories of the documents, and wherein said linking means automatically assigns the generated documents to an appropriate one of said categories of the documents that appears in the assigned file path.

10. The system of claim 7, wherein said linking means comprises a linkage database for storing the assigned file paths.

11. The system of claim 7, further comprising project creation means for creating a new one of the plural projects using said template, document form, and contacts databases.
